(19) United States
(12) Patent Application Publication
(10) Pub. No.: US 2004/0003058 A1
(43) Pub. Date: Jan. 1, 2004

(54) Integration of service registration and discovery in networks

(75) Inventor: Dirk Trossen, Cambridge, MA (US)

Correspondence Address: BANNER & WITCOFF, 1001 G STREET N W, SUITE 1100, WASHINGTON, DC, 20001, US

(73) Assignee: NOKIA, Inc., Irving, TX

(21) Appl. No.: 10/179,244

(22) Filed: Jun. 26, 2002

(51) Int. Cl. G06F 15/177; G06F 15/173

(52) U.S. Cl. 709/220; 709/223

(57) ABSTRACT

Systems and methods are provided for service registration and service discovery as part of device registration. In one embodiment, service registration and discovery are performed as part of session initiation protocol (SIP) device registration. In one embodiment steps for performing service registration of a device include sending a REGISTER message to a network entity having a payload including service description information, and sending a service registration message from the network entity to one or more service discovery agents. In one embodiment steps for performing service discovery for one or more devices meeting service requirements include sending a QUERY message to a network entity, the network entity sending a service discovery message to one or more service discovery agents, the service discovery agents responding to the network entity, and the network entity sending a SERVICE message to the requester.

### FIELD OF THE INVENTION

This invention relates generally to telecommunications networks. More particularly, the invention concerns systems and methods for integrating service registration and discovery with device registration.

### BACKGROUND OF THE INVENTION

In a network environment, it is often important for devices to discover available services in the network and to learn information about the configuration of those services. Service discovery, therefore, has been a topic for research and standardization for several years. As a result, protocols and products have been developed to allow for registration and discovery of services. Examples include the Internet protocol known as Service Location Protocol (SLP), JINI™ (a set of JAVA®application program interfaces (APIs) that enable a device to announce itself on a network and to provide some details about its capabilities), and the networking architecture known as Universal Plug and Play (UPnP).

One of the common architectural foundations for service discovery solutions is the existence of a service discovery agent (service agent), such as described in the Internet Engineering Task Force (IETF) document RFC 2608, “Service Location Protocol, Version 2, June 1999.” These agents typically serve a logical, administrative domain in which services subscribe with such agents to offer functionality to other entities. Services can be requested, i.e. discovered, by sending an appropriate request to a service agent that matches the requirements of the request against its repository of internal service subscription data. Although this general architecture may be common, particular embodiments differ in important details such as protocol messages, representation format for services, and objectives with respect to the particular environment. Accordingly, dedicated protocol stacks must be present for each different embodiment.

Multicast-based solutions, such as JINI™ and UPnP, or multicast mode versions of SLP, seek to avoid the existence of a centralized service agent. However, these solutions also suffer from certain drawbacks. For example, such multi-cast solutions generally require specific delivery paradigms. Additionally, they are typically inefficient due to flooding of service requests.

On a related topic, calling models such as Session Initiation Protocol (SIP) and ITU H.323 multimedia conferencing standard provide application layer signaling protocols related to multimedia sessions (see e.g. IETF document RFC 2543, “SIP: Session Initiation Protocol,” March 1999). SIP was generally developed to address problems with initiating a session between two or more endpoints in the Internet by making these endpoints aware of the session semantics. Accordingly, devices (or users that run certain applications on these devices) are registered with the SIP backbone so that an invitation to a particular session can be correctly delivered to these endpoints. To achieve this, SIP provides a registration mechanism for devices and users, and it applies mechanisms such as location servers and registrars to route the session invitations appropriately. SIP currently provides methods for discovering certain capabilities for known endpoints (i.e. OPTIONS method for querying a server as to its capabilities for a user); however, this does not apply to unknown endpoints.

### SUMMARY OF THE INVENTION

The present invention combines device registration, such as within a SIP infrastructure, with service registration including methods for service discovery. As such, the present invention provides methods for registering a device and service capabilities of the device with a service discovery agent in concert with a device registration process, such as between a device and a SIP proxy server. One such method includes the steps of creating a register message, which includes device information and service capability information, and sending the register message to a network entity that in turn registers the device and sends a service registration message to one or more service discovery agents. The service discovery agents each store the information and may return a confirmation message. Accordingly, transparent to the user, the device is both registered with a network entity, such as a SIP proxy, and with one or more associated service registration agents.

The invention further provides methods for service discovery. According to one such method, a requester creates a query message that describes service capabilities requested for a device and sends the query message to a network entity, such as a SIP proxy. The network entity sends a service discovery message to one or more service discovery agents, which in turn determine one or more devices having the requested capabilities and return such information to the network entity. The network entity sends a service message to the requester that describes one or more devices having the requested capabilities and provides information about their capabilities.

In one embodiment of the invention, the device is a terminal, such as an IP-enabled display device, that registers with a SIP proxy server. Transparent to the user, and based on information in the SIP REGISTER message sent to the proxy server, the proxy server registers the device and its service capabilities with one or more associated service discovery agents. In other embodiments of the invention, computer-executable instructions for implementing the disclosed methods are stored on computer-readable media. Other features and advantages of the invention will become apparent with reference to the following detailed description and figures.

### BRIEF DESCRIPTION OF THE DRAWINGS

The invention will be described in detail in the following description of preferred embodiments with reference to the following figures wherein:

FIG. 1 shows an architecture that supports service registration and discovery methods according to one embodiment of the invention;

FIG. 2 shows a functional diagram of a terminal device acting as the requester of FIG. 1;

FIG. 3 shows a functional diagram of a server, which is representative of the local SIP proxy and the local service discovery agent of FIG. 1;

FIG. 4 shows message flows between the entities of FIG. 1 for a service registration method according to one aspect of the invention;

FIG. 5 shows message flows between the entities of FIG. 1 for a service discovery method according to another aspect of the invention;

FIG. 6 shows an architecture that supports service registration and discovery methods according to another embodiment of the invention;

FIG. 7 shows a SIP REGISTER or SIP QUERY message according to the embodiment of FIG. 6;

FIG. 8 shows a SIP REGISTER or SIP QUERY message according to a further embodiment; and

FIG. 9 shows an architecture that supports service registration and discovery methods according to a further embodiment.

### DETAILED DESCRIPTION OF THE INVENTION

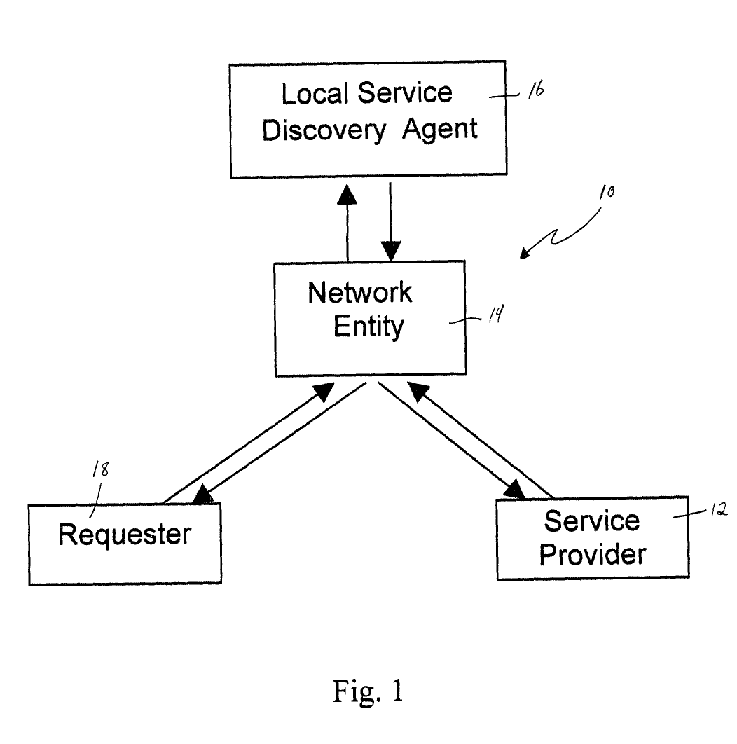

The invention may be embodied in various forms. Referring now to FIG. 1, an architecture 10 is shown that supports service registration and discovery methods according to one embodiment of the invention. The architecture 10 generally includes a service provider 12, a network entity 14 such as a local SIP proxy, a local discovery agent 16, and a requester 18. Service provider 12 may include a terminal device having service capabilities, such as being able to support multimedia sessions of various parameters. Service provider 12 is registered with network entity 14 to provide service communications via network entity 14. For example, network entity 14 may include a local SIP proxy that supports multimedia sessions with service provider 12. Local service discovery agent 16 (service agent) acts as a repository for storing service information about service providers within a particular domain. Requester 18 may be any device or entity that requests service information about service providers supported by network entity 14.

A method for service registration according to one embodiment of the invention generally includes service provider 12 registering with network entity 14 using a SIP REGISTER message. The SIP REGISTER message includes service information about service provider 12 in the form of a payload in the REGISTER message. Network entity 14 in turn registers the service capabilities of service provider 12 with service agent 16. A method for service discovery according to one embodiment of the invention includes a requester 18 querying network entity 14 for service capabilities of service providers supported thereby. Accordingly, network entity 14 queries service agent 16 for such information and the requested information is returned to requester 18.

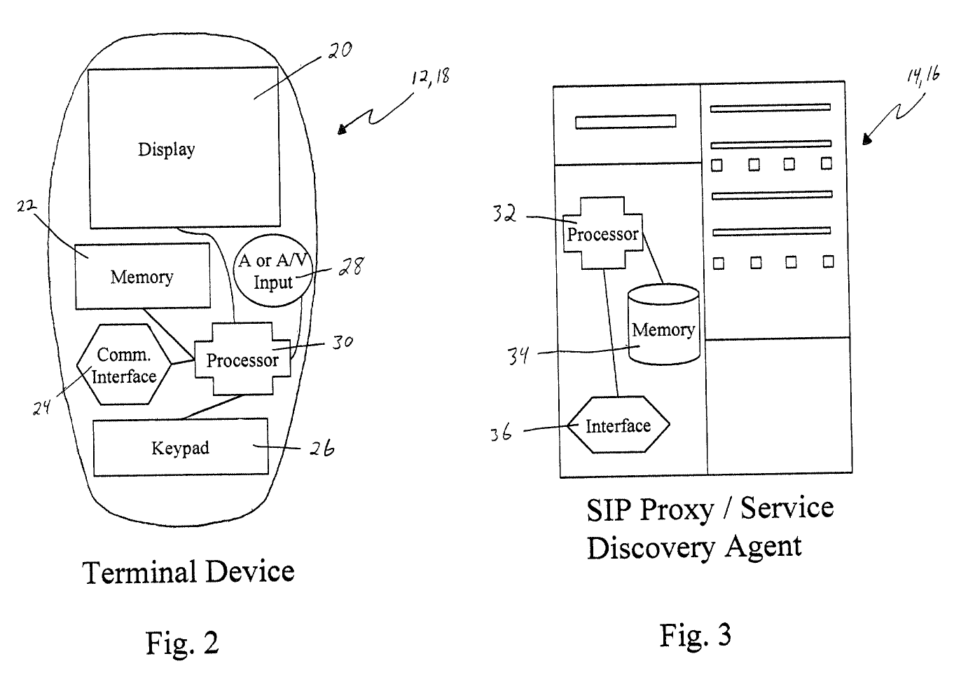

Referring now to FIG. 2, a functional diagram of a terminal device 12, 18 that may act as either a service provider 12 or a requester 18 according to one embodiment of the invention is shown. The terminal device 12, 18 generally includes a processor 30 connected to a display 20, a memory 22, a communication interface 24, a keypad 26, and an audio or audio/visual input 28. Stored within the memory 22 are instructions for creating messages related to the present invention, such as a REGISTER message or a QUERY message, which are described later. The terminal device 12, 18 may comprise a mobile telephone, personal digital assistant (PDA), IP-enabled display device, or other electronic device.

Referring now to FIG. 3, a functional diagram of a server that may act as network entity 14 or a service agent 16 is shown. Separate servers may act as network entity 14 or service agent 16, or a single server may support logically separate, but co-located, network entity 14 and service agent 16. Server 14, 16 generally includes a processor 32 connected to memory 34 and interface 36. Memory 34 contains instructions for processor 32 to perform steps associated with device/service registration and discovery. Further, in acting as a service agent, memory 34 may store device registration information including service capabilities.

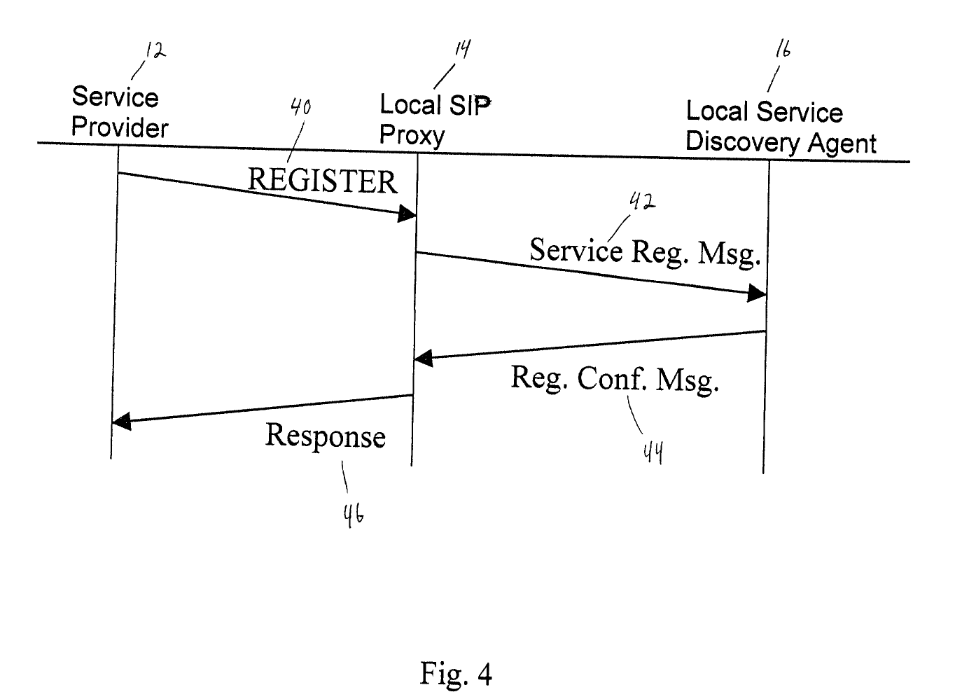

Referring now to FIG. 4 in particular, as well as FIGS. 1-3 in general, message flows for a service registration method according to the present invention are shown. Suppose that service provider 12 is an IP-enabled display device, such as a teleconference unit for a particular company. Suppose further that network entity 14 is a SIP proxy for the company's private network. Suppose also that service agent 16 is not co-located with SIP proxy 14, but is located within the company's private network.

Registration of display device 12 occurs with display device 12 sending a REGISTER message 40 in accordance with SIP procedures. However, the payload (not shown) of the REGISTER message 40 carries a description of services provided by display device 12. This description is not restricted to a single service description if display device 12 is providing several services. The format of REGISTER message 40 may be an attribute-based format, such as those used with Service Location Protocol (SLP) (see IETF document RFC 2608, “Service Location Protocol,” version 2, June 1999) or Resource Description Framework (RDF) (see “Resource Description Framework Model and Syntax Specific,” W3C Recommendation, Feb. 22, 1999). Further, a dedicated format for SIP service descriptions may be used. A dedicated format, however, would require standardization in appropriate standardization bodies, such as IETF.

Upon reception of REGISTER message 40, SIP proxy 14 registers service provider 12 according to the registration mechanisms for SIP. If the payload of the received REGISTER message 40 contains one or more service descriptions, SIP proxy 14 forms a service registration message 42 for service provider 12 and sends it to service agent 16. Service registration message 42 is formatted to be appropriate for the service agent 16 to which it is being sent. For example, it may have one format for an SLP-based service agent and another format for an RDF-based service agent.

Accordingly, SIP proxy 14 formats service registration message 42 to meet the protocol appropriate for service agent 16, as well as other requirements specific to service agent 16. This provides advantages over specialized service discovery procedures. For example, service provider 12 may create a REGISTER message according to a common SIP format without knowledge of specific requirements related to service provider 12, and yet service capabilities for service provider 12 may be registered with service agent 16. Further, beyond creation of the payload (not shown) in SIP REGISTER message 40, registration of its service capabilities may be transparent to service provider 12. As discussed later with regard to other embodiments, mapping of the REGISTER message 40 and the addition of an identifier to identify the service agent 16 in the REGISTER message may be appropriate for interpretation or forwarding of service information by SIP proxy 14.

Preferably, service agent 16 sends a registration confirmation message 44 to SIP proxy 14. However, the procedures related to service registration and discovery with service agent 16 depend on its particular requirements, which may not support registration confirmation. In a SIP environment, SIP proxy 14 sends a Response 46 to service provider 12, such as ‘200 OK’ return code indicating a successful registration.

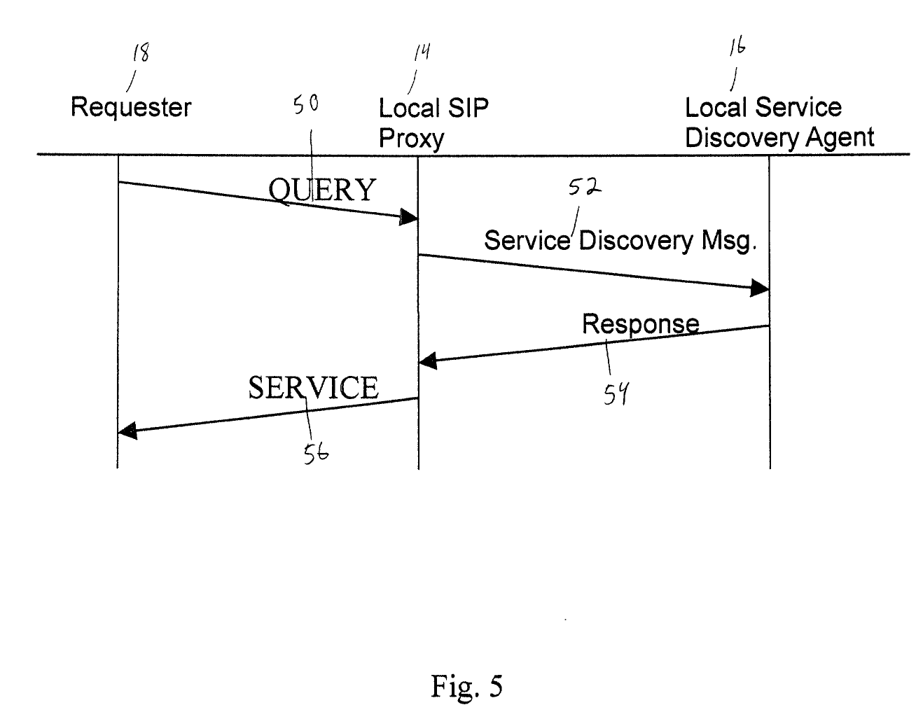

Referring now to FIG. 5 in particular, as well as FIGS. 1-3 in general, message flows for a service discovery method according to another embodiment of the present invention are shown. Suppose that requester 18 is a mobile terminal device. Suppose further that a user of the mobile terminal 18 is registered with a remote SIP proxy (not shown) while the user is traveling in his car and suppose that the user receives an IP-phone call while traveling in his car. Suppose also that the call contains video information, but that the video is not displayed due to lack of video output capabilities on mobile terminal 18. Suppose further that when the user arrives at his company, the call is handed over to the company's private network by applying mobile IP techniques. When registering with the company's private network, the user obtains the address of SIP proxy 14 that supports devices within his physical location within the company network. Suppose further that the user desires to complete his call via an IP-enabled display device within his company network.

In order to locate such a display device, mobile terminal 18 sends a QUERY message 50 to SIP proxy 14, which contains as a payload the description of the desired service (e.g. a video display of a certain quality). The format of the payload may be an attribute-based format, such as an SLP or RDF-based format, or a dedicated format for SIP service description might be used. Such a dedicated format requires standardization in appropriate standardization bodies, such as IETF. Further, the QUERY message 50 does not currently exist within SIP, but is proposed herein as an addition to the protocol.

Upon reception of the QUERY message 50, SIP proxy 14 forms an appropriate service discovery message 52 and sends it to service agent 16. As discussed later with regard to other embodiments, mapping of the payload of the QUERY message 50 and the addition of an identifier to identify the service agent 16 in the QUERY message 50 may be appropriate for interpretation or forwarding of service discovery by SIP proxy 14. Upon reception of service discovery message 52, service agent 16 determines one or more devices that meet the requirements of the desired service hosted by SIP proxy 14. Service agent 16 subsequently sends a service discovery response message 54 to SIP proxy 14 describing devices that meet the requested requirements. The format of the response message 54 may be an attribute-based format such as used in SLP or RDF-based formats. In addition, a dedicated SIP service description format may be used, which would require standardization in appropriate standardization bodies, such as IETF.

In the present example, suppose service agent 16 determines that service provider 12 meets the video display requirements for the ongoing IP-based phone call as requested. As such, service agent 16 returns the URL for display unit 12 in response message 54. SIP proxy 14 in turn sends a SERVICE message to mobile terminal 18 describing all found services that meet desired service requirements, which in this example includes display unit 12. The SERVICE message 56 and its format are not currently defined in SIP. However, the format of the SERVICE message 56 may be an attribute-based format such as used in SLP or RDF-based formats. In addition, a dedicated SIP service description format, such as text-based format, may be used that would require standardization in appropriate standardization bodies, such as IETF. Upon reception of the SERVICE message 56, mobile terminal 18 extracts received service descriptions, which in this example include the URL for display device 12. Mobile terminal 18 can now initiate the transfer of the video information from the caller to the IP display device 12 by sending a SIP INVITE message (not shown) to the IP-enabled display device 12.

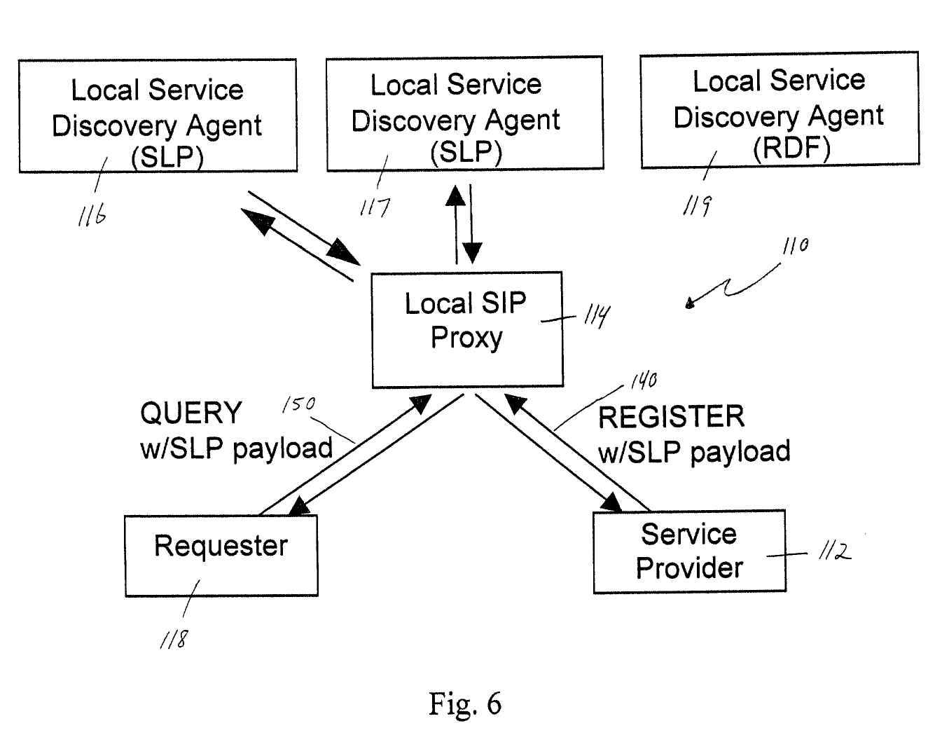

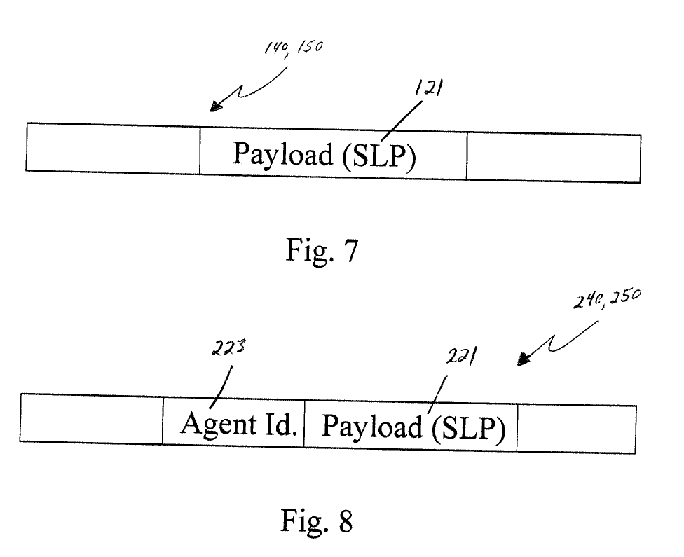

Referring now to FIGS. 6 and 7, an architecture 110 is shown in FIG. 6 that supports service registration and discovery methods according to another embodiment of the present invention. The architecture 110 differs from the previous embodiment in that multiple service agents 116, 117, 119 are shown within the private company network to which SIP proxy 114 belongs. As such, appropriate mapping of the QUERY message 150 and the REGISTER message 140 may be necessary for sending these messages to one or more appropriate service agents. According to one embodiment, SIP proxy 114 determines which service agent(s) to send REGISTER 140 or QUERY 150 messages to based on the payload of the respective message. For example, as shown in FIG. 7, the payload 121 of either of these messages may be identifiable by network entity 114 as being an SLP-based format. Accordingly, SIP proxy 114 may recognize this type format and therefore send related messages (e.g. service registration, service discovery) only to service agents set up for SLP-based messages. In one embodiment, the format type may be identified by a flag within the SIP message having a value associated with a format for the payload.

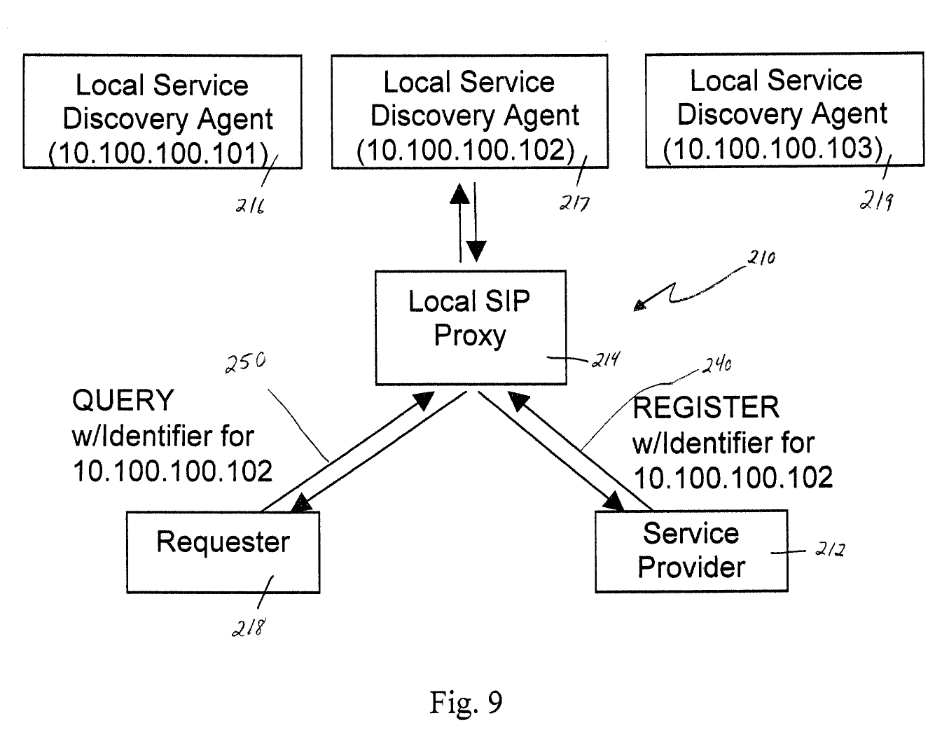

Referring now to FIGS. 8 and 9, an architecture 210 is shown in FIG. 9 that supports service registration and discovery methods according to a further embodiment of the present invention. The architecture 210 differs from the previous embodiment in that SIP proxy 214 determines which service agent(s) to send REGISTER 240 or QUERY 250 messages to based on an identifier of the respective message. For example, as shown in FIG. 8, an identifier 223 within either of these messages may explicitly identify a service agent to which to send the respective message. The identifier may, for example, identify one or more service agents according to their address within the private company network. Accordingly, SIP proxy sends related messages (e.g. service registration, service discovery) only to the identified service agent(s).

In a further embodiment (not shown), REGISTER and QUERY messages include service description and service discovery information having a standard format defined in SIP. According to such an embodiment, the service registration and service discovery messages may be sent to all service agents within the network of the SIP proxy (e.g. company network). In service discovery scenarios involving multiple service agents, it is preferable for the SIP proxy to wait for responses from all service agents before sending a SERVICE message to the requester. Further, it is preferable that the SERVICE message include service information for devices identified by all service agents.

While the present invention has been described in connection with the illustrated embodiments, it will appreciated and understood that modifications may be made without departing from the true spirit and scope of the invention. In particular, the invention applies to other session related protocols and to a variety of different devices and networks.

I claim:

1. A method of registering a device and service capabilities of said device with a service discovery agent, said method performed in concert with a device registration process between said device and a network entity, said method comprising the steps of:
creating a register message comprising identification information for said device and service capability information for said device;
sending said register message to said network entity for registering said device with said network entity; and
receiving a registration confirmation message from said network entity confirming registration with said service discovery agent.

2. The method of claim 1, wherein said register message comprises a device register message having a payload comprising said service capability information.

3. The method of claim 2, wherein said device register message comprises a SIP REGISTER message.

4. The method of claim 2, wherein said service capability information comprises information having an attribute-based format.

5. The method of claim 4, wherein said attribute-based format is selected from the group consisting of SLP and RDF.

6. The method of claim 1, wherein said register message further comprises an identifier identifying said service discovery agent.

7. A method of registering a device and service capabilities of said device with a service discovery agent, said method performed in concert with a device registration process between said device and a network entity, said method comprising the steps of:
receiving at said network entity a register message comprising identification information for said device and service capability information for said device;
registering said device at said network entity; and
sending a service registration message for said device to said service discovery agent, said service registration message comprising said service capability information.

8. The method of claim 7, wherein said register message comprises an identifier identifying said service discovery agent.

9. The method of claim 8 further comprising the steps of:
detecting said identifier; and
choosing said service discovery agent based on said identifier.

10. The method of claim 7, further comprising the steps of:
recognizing a format of said service capability information; and
selecting said service discovery agent based on said recognized format.

11. The method of claim 7, further comprising the steps of:
receiving a registration confirmation message from said service discovery agent; and
sending a registration confirmation message to said device.

12. A method for performing service discovery, comprising:
receiving at a network entity a query message from a requester requesting identification of an entity registered with said network entity having requested service capabilities;
sending a service discovery message to a service discovery agent;
receiving a service discovery response from said service discovery agent identifying a device as substantially matching said requested service capabilities and describing available service capabilities for said device; and
sending a service message to said requester identifying said device and describing said available service capabilities for said device.

13. The method of claim 12, wherein said query message comprises a payload comprising said requested service capability information.

14. The method of claim 13, further comprising the steps of:
recognizing a format of said payload; and
selecting said service discovery agent based on said recognized format.

15. The method of claim 12, wherein said query message comprises a SIP QUERY message.

16. The method of claim 12, wherein said requested service capability information comprises information having an attribute-based format.

17. The method of claim 16, wherein said attribute-based format is selected from the group consisting of SLP and RDF.

18. The method of claim 12, wherein said query message comprises an identifier identifying said service discovery agent.

19. The method of claim 18, further comprising the steps of:
detecting said identifier; and
choosing said service discovery agent based on said identifier.

20. A method of registering a device and service capabilities of said device with a service discovery agent, said method performed in concert with a device registration process between said device and a network entity, said method comprising the steps of:
receiving at said service discovery agent a register message from a network entity at which said device is registered, said register message comprising identification information for said device and service capability information for said device; and
storing said identification information and said service capability information.

21. The method of claim 20, further comprising the step of sending a registration confirmation message to said network entity.

22. A method for performing service discovery, comprising:
receiving at a service discovery agent a query message from a network entity, said query message comprising information describing a service requested for communicating with said device;
matching service capability information of said device with said service description information; and
sending a service message to said network entity describing service capabilities for said device.

23. A method of determining a device registered with a network entity having requested service capabilities for communications with said device, said method comprising the steps of:
creating a query message comprising information describing said service capabilities requested for communicating with said undetermined device registered with said network entity;
sending said query message to said network entity; and
receiving a service message describing said device registered with said network entity and service capabilities for said device.

24. A computer-readable medium having computer-readable instructions for performing steps for registering a device and service capabilities of said device with a service discovery agent in concert with a device registration process between said device and a network entity, said steps comprising:
receiving at said network entity a register message comprising identification information for said device and service capability information for said device;
registering said device at said network entity; and
sending a service registration message for said device to said service discovery agent, said service registration message comprising said service capability information.

25. The computer-readable medium of claim 24, wherein said register message comprises an identifier identifying said service discovery agent.

26. The computer-readable medium of claim 25, said steps further comprising:
detecting said identifier; and
choosing said service discovery agent based on said identifier.

27. A computer-readable medium having computer-readable instructions for performing steps for performing service discovery, said steps comprising:
receiving at a network entity a query message from a requester requesting identification of an entity registered with said network entity having requested service capabilities;
sending a service discovery message to a service discovery agent;
receiving a service discovery response from said service discovery agent identifying a device as substantially matching said requested service capabilities and describing available service capabilities for said device; and
sending a service message to said requester describing said available service capabilities for said device.

28. A computer-readable medium having computer-readable instructions for performing steps for determining a device registered with a network entity having requested service capabilities for communications with said device, said steps comprising:
creating a query message comprising information describing said service capabilities requested for communicating with said undetermined device registered with said network entity;
sending said query message to said network entity; and
receiving a service message describing said device registered with said network entity and service capabilities for said device.

29. A terminal comprising:
a memory containing instructions for registering a device and service capabilities of said device with a service discovery agent in concert with a device registration process between said device and a network entity; and
a processor for performing steps according to said instructions stored in said memory, said steps comprising:
creating a register message comprising identification information for said device and service capability information for said device;
sending said register message to said network entity for registering said device with said network entity; and
receiving a registration confirmation message from said network entity confirming registration with said service discovery agent.

30. A network entity comprising:
a memory containing instructions for registering a device and service capabilities of said device with a service discovery agent in concert with a device registration process between said device and a network entity; and
a processor performing steps according to said instructions stored in said memory, said steps comprising:
receiving at said network entity a register message comprising identification information for said device and service capability information for said device;
registering said device at said network entity; and
sending a service registration message for said device to said service discovery agent, said service registration message comprising said service capability information.

31. A network entity comprising:
a memory containing instructions for determining a device registered with a service discovery agent having requested capabilities; and
a processor performing steps according to said instructions stored in said memory, said steps comprising:
receiving a query message from a requester requesting identification of an entity registered with a network entity having requested service capabilities;
sending a service discovery message to said service discovery agent;
receiving a service discovery response from said service discovery agent identifying said device as substantially matching said requested service capabilities and describing available service capabilities for said device; and
sending a service message to said requester identifying said device and describing said available service capabilities for said device.

32. A terminal comprising:
a memory containing instructions for determining a device registered with a network entity having requested service capabilities for communications with said device; and
a processor for performing steps according to said instructions stored in said memory, said steps comprising:
creating a query message comprising information describing said service capabilities requested for communicating with said undetermined device registered with said network entity;
sending said query message to said network entity; and
receiving a service message describing said device registered with said network entity and service capabilities for said device.

33. A service discovery agent comprising:
a memory containing instructions for registering a device and service capabilities of said device in concert with a device registration process between said device and a network entity; and
a processor performing steps according to said instructions stored in said memory, said steps comprising
receiving at said service discovery agent a register message from a network entity at which said device is registered, said register message comprising identification information for said device and service capability information for said device; and
storing identification information and service capability information.

34. A service discovery agent comprising:
a memory containing instructions for determining a device registered with a service discovery agent having requested service capabilities; and
a processor performing steps according to said instructions stored in said memory, said steps comprising:
receiving a query message from a network entity, said query message comprising information describing a service requested for communicating with a device;
determining said device based on said service description information; and
sending a service message to said network entity describing available service capabilities for said device.
